(19) United States
(12) Patent Application Publication
(10) Pub. No.: US 2013/0265285 A1
(43) Pub. Date: Oct. 10, 2013

(54) OPTICAL FIBER PROXIMITY SENSOR

(71) Applicants: Jose P. Piccolotto, Cordoba (AR); Gustavo D. Domingo Yaguez, Cordoba (AR)

(72) Inventors: Jose P. Piccolotto, Cordoba (AR); Gustavo D. Domingo Yaguez, Cordoba (AR)

(21) Appl. No.: 13/976,016

(22) PCT Filed: Sep. 29, 2011
(86) PCT No.: PCT/US11/53962

§ 371 Date: Jun. 25, 2013

(51) Int. Cl. G01B 11/14; G06F 3/042

(52) U.S. Cl. CPC G01B 11/14; G06F 3/0421
USPC 345/175; 250/349

(57) ABSTRACT

Various embodiments are directed to a proximity sensor apparatus. A light source may emit light that is conducted through multiple optical fibers, each having a source end and an emission end. The multiple optical fibers emit the light out the emission end and are arranged such that the emission ends form a grid. Multiple photoelectric sensors, each substantially co-located with each of the multiple optical fibers at the emission end are operative to detect emitted light that has been reflected back off an object. A processing component may be communicatively coupled with the multiple photoelectric sensors and receive signals from the multiple photoelectric sensors. The signals may be indicative of the detected emitted light that has been reflected back. The signals may be processed to determine a distance from the multiple photoelectric sensors to the object that reflected the emitted light.

### BACKGROUND

Touchscreens on mobile devices, portable computing devices, and other computing devices have broadened the scope of user input data and ushered in the next generation of user interface interaction. Touchscreens permit user interaction with the operating system and/or a multitude of applications via a user interface executable on a computing device. In general, a touchscreen can detect the (X,Y) position of an object (e.g., a finger or a pen stylus) when it contacts the touchscreen. The user interface can then utilize that information via a processing component to initiate one or more actions based on the location of the contact with the touchscreen. As a basic example, a user may contact a portion of the touchscreen that is displaying an icon representative of an application. The processing component may be able to launch the application associated with the icon based on the contact with that portion of the touchscreen. Touchscreens are generally limited to two-dimensional planar sensitivity and do not respond to objects that are not in direct contact with or very close proximity to the touchscreen surface. Accordingly, there may be a need for improved techniques to solve these and other problems.

### BRIEF DESCRIPTION OF THE DRAWINGS

FIG. 1 illustrates one embodiment of a proximity sensor apparatus integrated into a portable electronic device.

FIG. 2 illustrates one embodiment of proximity sensor apparatus components.

FIG. 3 illustrates another embodiment of a proximity sensor apparatus integrated into a portable electronic device (PED).

FIG. 4 illustrates another embodiment of proximity sensor apparatus components.

FIG. 5 illustrates another embodiment of proximity sensor apparatus components.

FIG. 6 illustrates another embodiment of a proximity sensor apparatus integrated into a portable electronic device (PED).

FIG. 7 illustrates one embodiment of proximity sensor apparatus processing components.

FIG. 8 illustrates another embodiment of proximity sensor apparatus processing components.

FIG. 9 illustrates another embodiment of proximity sensor apparatus processing components.

FIG. 10 illustrates one embodiment of a logic flow.

FIG. 11 illustrates one embodiment of a computing architecture.

### DETAILED DESCRIPTION

In various embodiments, a proximity sensor apparatus may address common deficiencies associated with current touchscreen apparatuses.

The proximity sensor apparatus may utilize, in some embodiments, multiple optical fibers. The optical fibers may be open on one end and operative to conduct light and may be arranged such that the open ends for the multiple optical fibers form a grid. Multiple light emitting diodes (LEDs) may be communicatively coupled with corresponding optical fibers. The multiple LEDs may be operative to emit infrared (IR) light through the corresponding optical fiber and out the open end. Multiple photoelectric sensors may be communicatively coupled with the optical fibers. The multiple photoelectric sensors may be operative to detect emitted light that has been reflected back off an object into the open end of the multiple optical fibers.

A processing component may be communicatively coupled with the multiple photoelectric sensors. The processing component may be operative to receive signals from the multiple photoelectric sensors. The signals may be indicative of the reflected detected emitted light that has been reflected back through the open ends of the multiple optical fibers. The processing component may also process the signals to determine a distance from the open ends of the multiple optical fibers to the object that reflected the emitted light.

To prevent false light detection, a modulation component may be coupled with the LEDS and may be operative to modulate the emitted light to a specific pattern. The processing component may be operative to filter the signals indicative of the detected emitted light to disregard light not matching the modulated specific pattern.

The processing component may be operative to determine a planar location of the object, such as Cartesian (X,Y) coordinates of the object in accordance with a Cartesian coordinate system, based on a grid location for the open ends of the multiple optical fibers that detected the reflected emitted light. Using this information, the processing component may be operative to initiate an action based on the Cartesian (X,Y) coordinates and the distance from the open ends of the multiple optical fibers to the object that reflected the emitted light.

In some embodiments, the multiple optical fibers used to emit the LED light may be the same optical fibers that are used to detect the reflected light. Alternatively, a separate set of multiple optical fibers may be used to detect the reflected light. In addition, the emitted light may be emitted from one or more LEDs that are separately operated.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

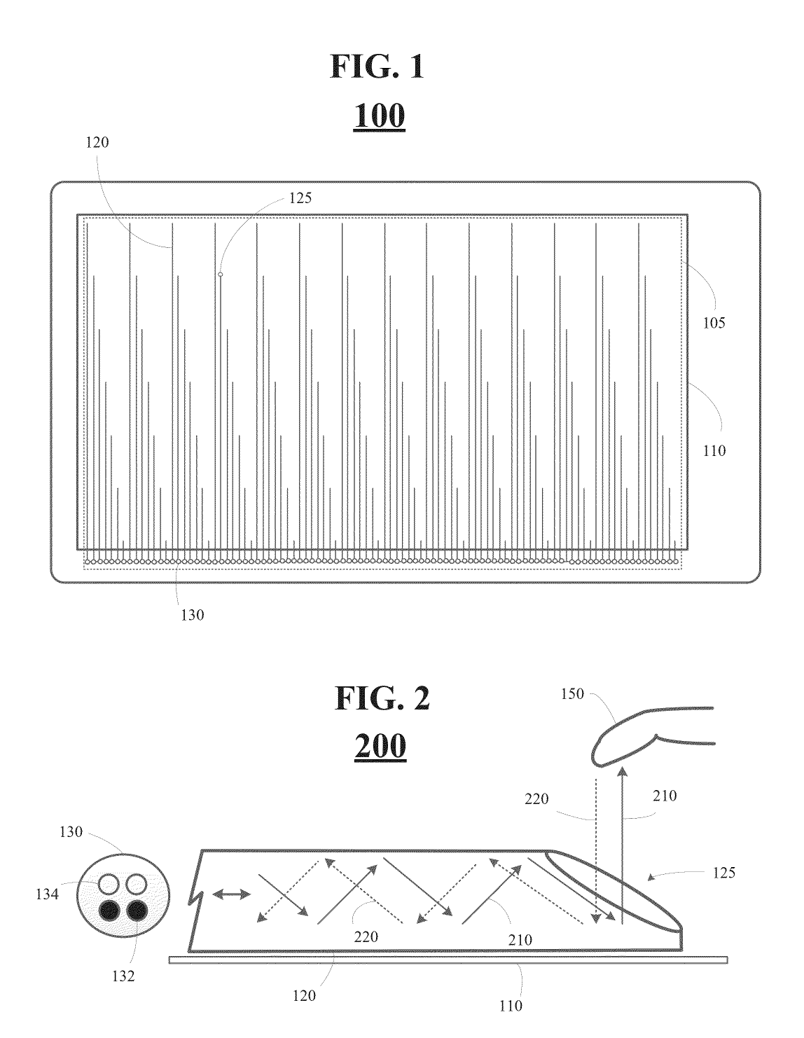

FIG. 1 illustrates one embodiment of a proximity sensor apparatus 105 integrated into a portable electronic device (PED) 100. PED 100 may be a smartphone, a handheld tablet computer, or the like. PED 100 may also include a touchscreen component 110 operative to receive and process physical user input. The proximity sensor apparatus may include multiple optical fibers 120. The multiple optical fibers 120 each terminate in an open end 125. The term “open end” refers to an end of an optical fiber that can directionally emit light that has traversed the optical fiber into the environment and/or can receive reflected light through the opening and conduct it back along the length of the optical fiber. The open ends 125 of the multiple optical fibers 120 may be arranged to form a grid overlaying the surface of touchscreen 110. Each of the multiple optical fibers may also terminate at another end in which a sensor apparatus 130 may be present.

In one embodiment, the multiple optical fibers 120 may be transparent so as not to be visible by a user or obstruct the graphics on a display unit that may be positioned beneath the array of multiple optical fibers 120. The embodiments are not limited in this context.

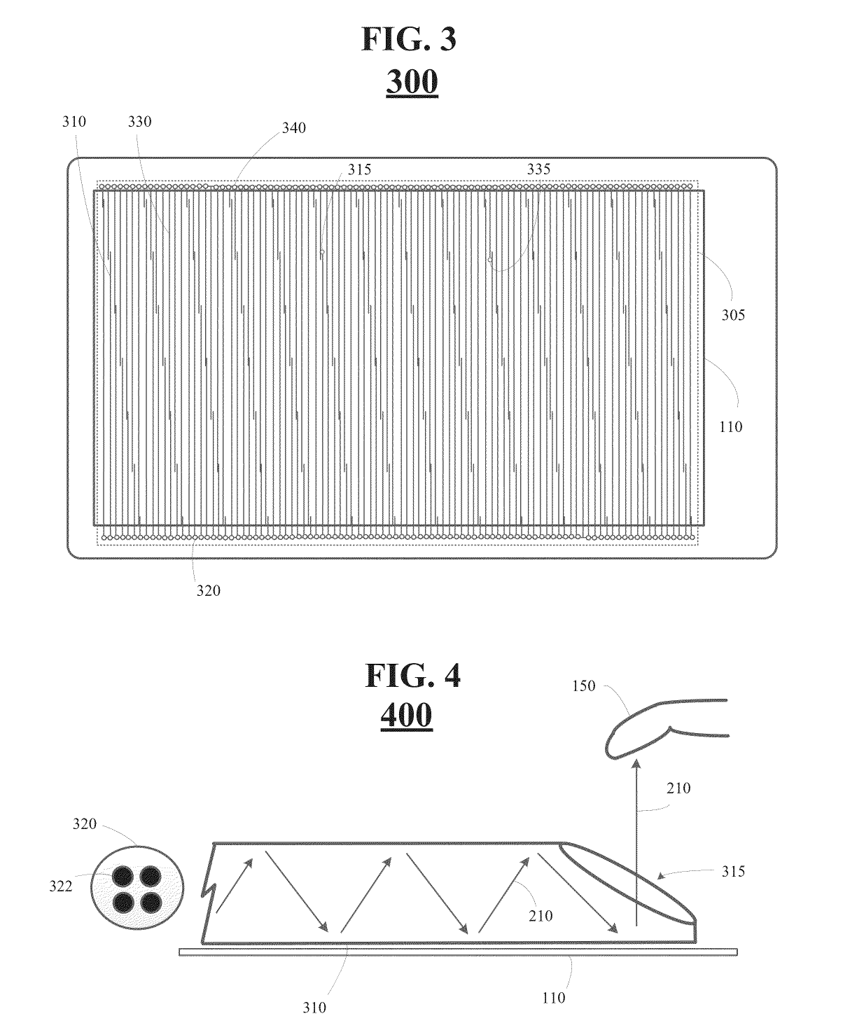

FIG. 2 illustrates one embodiment 200 of proximity sensor apparatus components. A sensor apparatus 130 may be positioned at one end of an optical fiber 120. In this embodiment, the sensor apparatus 130 includes one or more light sources 132 and one or more photoelectric sensors 134. The light source(s) 132 may be, for example, light emitting diodes (LEDs) that may be operative to emit infrared (IR) light. In operation, the light source(s) 132 may emit IR light 210 through optical fiber 120 and out end 125. The emitted IR light 210 may pass into the environment as indicated by the arrows. If there is an object 150 present such as a finger, for example, the object 150 may reflect the emitted IR light 210. The reflected light 220 may follow a return path into the open end 125 of optical fiber 120 and traverse the optical fiber 120 until it strikes sensor apparatus 130. The photoelectric sensors 134 on sensor apparatus 130 may then detect the reflected light 220. The embodiments are not limited in this context.

FIG. 3 illustrates another embodiment of a proximity sensor apparatus 305 integrated into a portable electronic device (PED) 300. PED 300 may be a smartphone, a handheld tablet computer, or the like. PED 300 may also include a touchscreen component 110 operative to receive and process physical user input. In this embodiment, there may be two sets of multiple optical fibers. A first set of multiple optical fibers 310 may be operative to emit light while a second set of multiple optical fibers 330 may be operative to detect light. Both sets of multiple optical fibers 310, 330 may include an open ends 315, 335 respectively and may be arranged to form a grid overlaying the surface of touchscreen 110. The first set of optical fibers 310 may each terminate at another end in which a light source 320 may be present. The second set of optical fibers 330 may each terminate at another end in which a sensor apparatus 340 may be present.

In one embodiment, the multiple optical fibers 310, 330 may be transparent so as not to be visible by a user or obstruct the graphics on a display unit that may be positioned beneath the array of multiple optical fibers 310, 330. The embodiments are not limited in this context.

FIG. 4 illustrates another embodiment 400 of proximity sensor apparatus components. In this embodiment, an optical fiber 310 from the first set is illustrated. A light source 320 may be positioned at one end of an optical fiber 310. In this embodiment, the light source 320 may includes one or more elements 322. The elements 322 may be, for example, light emitting diodes (LEDs) that may be operative to emit infrared (IR) light. In operation, the elements 322 may emit IR light 210 through optical fiber 310 and out end 315. The emitted IR light 210 may pass into the environment as indicated by the arrows. If there is an object 150 present such as a finger, for example, the object 150 may reflect the emitted IR light 210. The embodiments are not limited in this context.

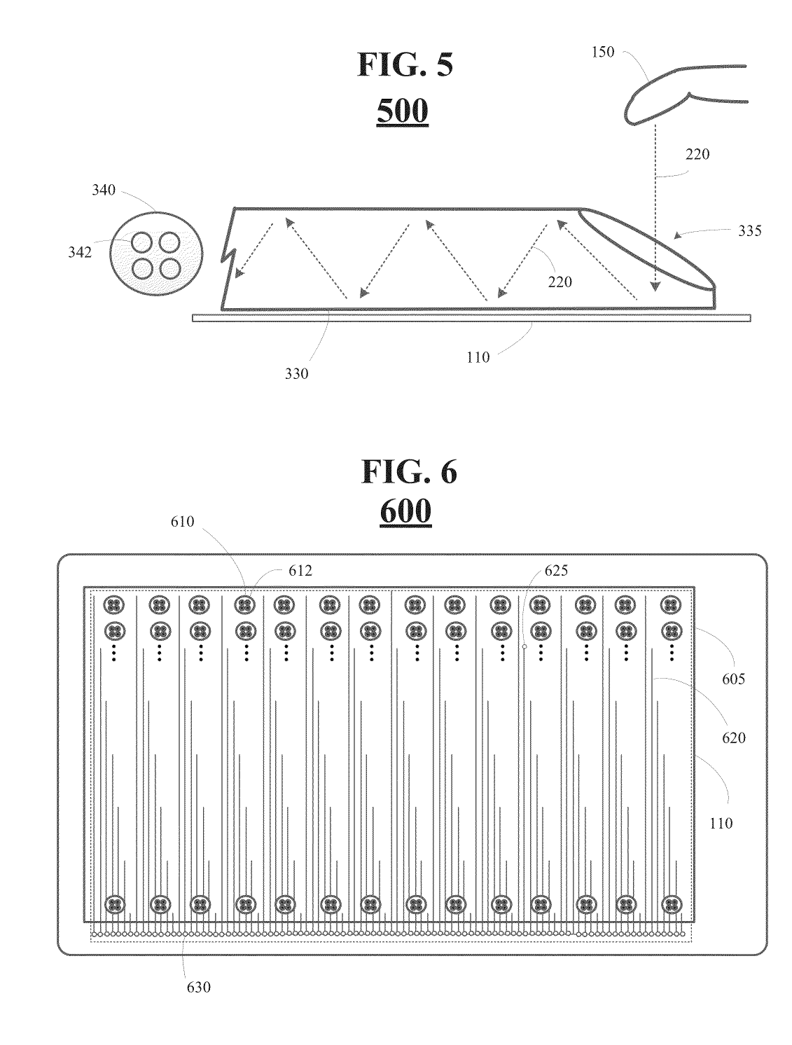

FIG. 5 illustrates another embodiment of proximity sensor apparatus components. In this embodiment, an optical fiber 330 from the second set is illustrated. A sensor apparatus 340 may be positioned at one end of an optical fiber 330. In this embodiment, the sensor apparatus 320 may include one or more photoelectric sensors 342. The reflected light 220 may follow a return path into the open end 335 of optical fiber 330. The reflected light 220 may then traverse the optical fiber 330 until it strikes the photoelectric sensors 342 of sensor apparatus 340. The photoelectric sensors 342 of sensor apparatus 340 may then detect the reflected light 220. The embodiments are not limited in this context.

FIG. 6 illustrates another embodiment of a proximity sensor apparatus 605 integrated into a portable electronic device (PED) 600. PED 600 may be a smartphone, a handheld tablet computer, or the like. PED 600 may also include a touchscreen component 110 operative to receive and process physical user input. In this embodiment, one or more light sources may be integrated with the pixels 610 of touchscreen component 110 of PED 600 and may be operative to emit light. In this embodiment, the light source(s) may include one or more elements 612. The elements 612 may be, for example, light emitting diodes (LEDs) that may be operative to emit infrared (IR) light. In operation, the LED elements 612 may be arranged within the touchscreen and may emit IR light from each pixel 610 in touchscreen 110. The other LED elements in each pixel 610 may emit red, green and blue light. If there is an object present such as a finger, for example, the object may reflect the emitted IR light. The pixels 610 illustrated in FIG. 6 are not necessarily to scale so as to better illustrate the structure. The embodiments are not limited in this context.

A set of multiple optical fibers 620 may be operative to detect light. The multiple optical fibers 620 each terminate in an open end 625. The open ends 625 of the multiple optical fibers 620 may be arranged to form a grid overlaying the surface of touchscreen 110. Each of the multiple optical fibers may also terminate at another end in which a sensor apparatus 630 may be present. In this embodiment, the sensor apparatus 630 may include one or more photoelectric sensors similar to those illustrated in FIG. 5. The reflected light may follow a return path into the open end 625 of optical fiber 620. The reflected light may then traverse the optical fiber 620 until it strikes the photoelectric sensors of sensor apparatus 630. The photoelectric sensors of sensor apparatus 630 may then detect the reflected light in a manner similar to that described with reference to FIG. 5.

In one embodiment, the multiple optical fibers 620 may be transparent so as not to be visible by a user or obstruct the graphics on a display unit that may be positioned beneath the array of multiple optical fibers 620. The embodiments are not limited in this context.

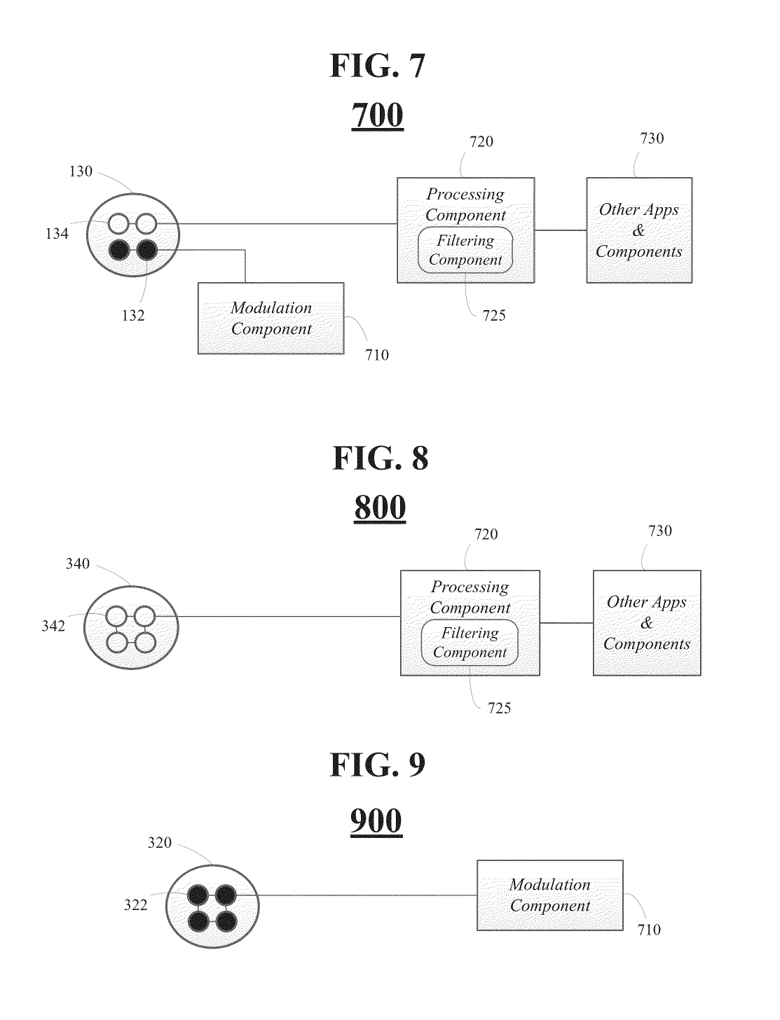

FIG. 7 illustrates one embodiment 700 of proximity sensor apparatus processing components. A sensor apparatus 130 from FIG. 1 is shown and may be communicatively coupled with a modulation component 710 and a processing component 720. In this embodiment, the sensor apparatus 130 includes both a light source 132 and photoelectric sensors 134 as is shown in and described with respect to FIGS. 1-2. The modulation component 710 may be operative to modulate the light emitted from light source 132 to a specific pattern. The modulation may be accomplished by turning the light source 132 on and off thousands of times per second in a particular sequence that forms a the pattern. The embodiments are not limited in this context.

The processing component 720 may include a filtering component 725 that may be operative to filter signals indicative of detected reflected light. Signals indicative of detected reflected light may be indicative of an object above the surface of a touchscreen as can be seen in FIG. 1 and may be received from the photoelectric sensors 134 of sensor apparatus 130. These signals may be filtered according to the modulation pattern that may have been implemented by the modulation component 710 when the light may have been emitted by light source 132. By emitting the light in a known pattern, reflected light that is detected can be filtered to remove environmental interference that may produce noise in the reflected light. Thus, only light emitted by light source 132 may be detected and acted upon by processing component 720. The embodiments are not limited in this context.

The processing component 720 may be operative to determine the (X,Y) coordinates of the object with respect to touch screen based on a grid location for the open ends of the multiple optical fibers that conducted the detected reflected emitted light. The processing component 720 may be further operative to determine the distance the object may be from the open ends of the multiple optical fibers. The distance may be calculated based on factors inherent in the detected reflected light. One such factor may be the intensity of the reflected light. Reflected light of greater intensity indicates an object is closer to the touchscreen than an object reflecting light at a lesser intensity.

Another factor may be the dispersion of the detected reflected light. The dispersion of the light will be greater when more photoelectric sensors detect the reflected light from an object. The dispersion of the light will be less when fewer photoelectric sensors detect the reflected light from an object. The dispersion of light is related to the distance an object may be from the touchscreen. The closer an object is to the touchscreen the less the dispersion because it will reflect the light to a more limited surface area on the touchscreen. Conversely, the further an object is from the touchscreen the greater the dispersion because it will reflect the light to a greater surface area on the touchscreen. The embodiments are not limited in this context.

The processing component 720 may be communicatively coupled with other applications and components 730 within the portable electronic device allowing for actions or tasks to be initiated based on the (X,Y) coordinates of the object and the distance from the touchscreen to the object that reflected the emitted light. The embodiments are not limited in this context.

FIG. 8 illustrates another embodiment 800 of proximity sensor apparatus processing components. A sensor apparatus 340 from FIG. 3 is shown and may be communicatively coupled with a processing component 720. In this embodiment, the sensor apparatus 340 includes photoelectric sensors 342 as is shown in and described with respect to FIGS. 3 and 5. The processing component 720 may include a filtering component 725 and may be communicatively coupled with other applications and components 730 within the portable electronic device. The functions of processing component 720, filtering component 725 and the other applications and components 730 have been previously described with respect to FIG. 7 above. The embodiments are not limited in this context.

FIG. 9 illustrates another embodiment 900 of proximity sensor apparatus processing components. A light source 320 from FIG. 3 is shown and may be communicatively coupled with a modulation component 710. In this embodiment, the light source 320 includes elements 322 as is shown in and described with respect to FIGS. 3-4. The modulation component 710 may be operative to modulate the light emitted from elements 322 to a specific pattern similar to that performed by spread spectrum techniques. The embodiments are not limited in this context.

Included herein are one or more flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

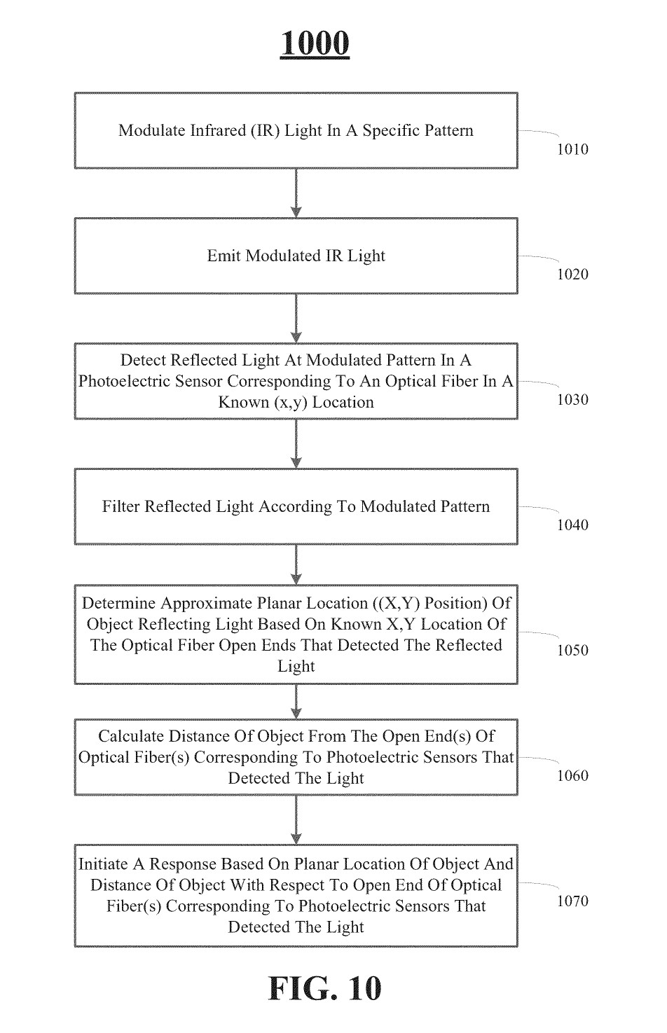

FIG. 10 illustrates one embodiment of a logic flow 1000 in which the distance an object is from a touchscreen for a portable electronic device may be calculated. The logic flow 1000 may be representative of some or all of the operations executed by one or more embodiments described herein.

A proximity sensor apparatus may implement a method in which light may be conducted from a light source through multiple optical fibers and out an open end of each optical fiber. The multiple optical fibers may be communicatively coupled on another end with a corresponding light source. The multiple optical fibers may be arranged such that the open ends form a grid that overlays the touchscreen surface of the portable electronic device. The proximity sensor apparatus may implement multiple photoelectric sensors to detect emitted light that has been reflected back off an object that may be a short distance above the grid of optical fiber open ends. In one embodiment, the photoelectric sensors may be substantially co-located with the light sources within each of the optical fibers. In another embodiment, the photoelectric sensors may be located within a second set of optical fibers that may be arranged in a grid formation similar to the light emitting set of optical fibers.

The proximity sensor apparatus may implement a processing component that may receive signals from the multiple photoelectric sensors in which the signals may be indicative of the detected emitted light that has been reflected back. The processing component may determine a distance that the object may be above the grid based on the signals. The proximity sensor apparatus may emit light in an invisible frequency range, specifically the infrared (IR) range. The proximity sensor apparatus may modulate the light emitted from the light source in a specific pattern. The modulation may be done to create a unique light signature such that reflected light from the light source can be filtered by the apparatus to distinguish it from other ambient or environmental light.

In the illustrated embodiment shown in FIG. 10, a proximity sensor apparatus may modulate infrared (IR) light from a light source in a specific pattern at block 1010. For example, a modulation component coupled with a light source may generate and modulate the light in a specific pattern in order to provide the emitted light with a unique identifying characteristic. The modulation may be similar to, for example, spread spectrum techniques. The embodiments are not limited to this example.

The logic flow 1000 may emit light from each optical fiber in a grid of multiple optical fibers at block 1020. For example, the light source may generate the modulated IR light which may be conducted through multiple optical fibers and out an open end for each of the optical fibers into the immediate environment. The open ends of the optical fibers may be arranged in an (X,Y) grid overlaying a touchscreen apparatus, for instance. The embodiments are not limited to this example.

The logic flow 1000 may detect reflected light in the modulated pattern in a photoelectric sensor corresponding to an optical fiber in a known location at block 1030. For example, in one embodiment, a corresponding grid of optical fibers may each include a photoelectric sensor. In another embodiment, the photoelectric sensors may be substantially co-located with the light sources on an integrated sensor apparatus and may utilize the same optical fibers used to emit the modulated IR light. The photoelectric sensors may detect light that has been reflected off an object positioned above one or more of the optical fiber ends.

In the embodiment in which the light sources and photoelectric sensors are co-located within the same optical fiber, the reflected light may re-enter the open end may traverse the length of the optical fiber until it strikes the photoelectric sensors. In the embodiment in which the light sources and photoelectric sensors are in separate optical fibers, the reflected light may enter the open end(s) of the non light emitting optical fiber(s) and may traverse the length of the optical fiber(s) until it strikes the photoelectric sensors. The photoelectric sensors may relay signals indicative of the detected light to a processing component. The embodiments are not limited to this example.

The logic flow 1000 may filter detected reflected light according to the modulated pattern at block 1040. For example, a filtering component under control of the processing component may filter the signals indicative of the detected light according to the modulation pattern applied by the modulation component. The modulation scheme imparts unique identifying characteristics to the emitted light. The proximity sensor apparatus may only be interested in light detected by the photoelectric sensors that was originally emitted by the optical fibers. Other detected light such as ambient light or sunlight may be irrelevant to object distance calculations since the source(s) of such other light are unknown and do not factor into any distance calculations. The embodiments are not limited to this example.

The logic flow 1000 may determine an approximate planar location (e.g., (X,Y) coordinates) of an object reflecting light, such as, for instance, a finger or a stylus, based on a known location of the optical fiber open end(s) that detected the reflected light at block 1050. For example, the signals indicative of the detected light may be attributable to a small subset of photoelectric sensors within the grid formed by the open ends of the optical fibers. The grid may be laid out such that the planar location (e.g., (X,Y) coordinates) for each open end of an optical fiber associated with a photoelectric sensor is known. Determining the approximate planar location of an object reflecting the modulated emitted light may entail determining which of the photoelectric sensors may have provided the signals indicative of the detected light. The embodiments are not limited to this example.

The logic flow 1000 may calculate the distance of the object from the open end(s) of the optical fiber(s) corresponding to the photoelectric sensors that detected the reflected light at block 1060. The distance may be calculated based on factors inherent in the detected reflected light. One such factor may be the intensity of the reflected light. Reflected light of greater intensity indicates an object is closer to the touchscreen than an object reflecting light at a lesser intensity.

Another factor may be the dispersion of the detected reflected light. The dispersion of the light will be greater when more photoelectric sensors detect the reflected light from an object. The dispersion of the light will be less when fewer photoelectric sensors detect the reflected light from an object. The dispersion of light is related to the distance an object may be from the touchscreen. The closer an object is to the touchscreen the less the dispersion because it will reflect the light to a more limited surface area on the touchscreen. Conversely, the further an object is from the touchscreen the greater the dispersion because it will reflect the light to a greater surface area on the touchscreen. The embodiments are not limited in this context.

The logic flow 1000 may initiate a response based on the approximate planar location (e.g., X,Y coordinates) of the object and the distance of the object with respect to the grid of optical fiber open ends at block 1070. For example, the proximity sensor apparatus may be implemented in a portable electronic device (PED) such as a smartphone. The smartphone may be equipped with a touchscreen operative to detect and interpret user actions. The proximity sensor apparatus may determine that an object is approximately three (3) centimeters above the touchscreen at an approximate (X,Y) location that corresponds with an icon displayed on the smartphone display. This distance (especially if it is decreasing over time) may be interpreted by the processing component as the user's intent to interact with this icon. As such, the processing component may initiate one or more actions based on the (X,Y) location and decreasing distance of the object to the touchscreen 110.

One action, for example, may be to pop-up a hidden menu that includes one or more options for the icon such as, for instance, open, delete, move to a folder, or hide. The user may now re-direct the object to contact the touchscreen at a point corresponding to one of the aforementioned hidden menu options. The embodiments are not limited to this example.

Another action may be to extend navigation or user interface actions to include the third dimension of distance particularly since changes in distance of an object to the surface of the touchscreen can be measured over time.

In one example, the planar coordinates of an object may suggest that the object is hovering above a volume control icon or graphic for a graphical user interface (GUI) currently being displayed by the portable electronic device. The volume may be controlled based on the distance of the object to the touchscreen. For example, moving the object closer to the touchscreen may cause the processing component to lower the volume of the portable electronic device while moving the object further from the touchscreen may cause the processing component to raise the volume of the portable electronic device. The processing component may be operative to perform similar functions for other GUI icons that utilize a sliding scale to control an aspect of the portable electronic device. Another example may be dimming or brightening the backlighting of the display component of the portable electronic device. The embodiments are not limited to these examples.

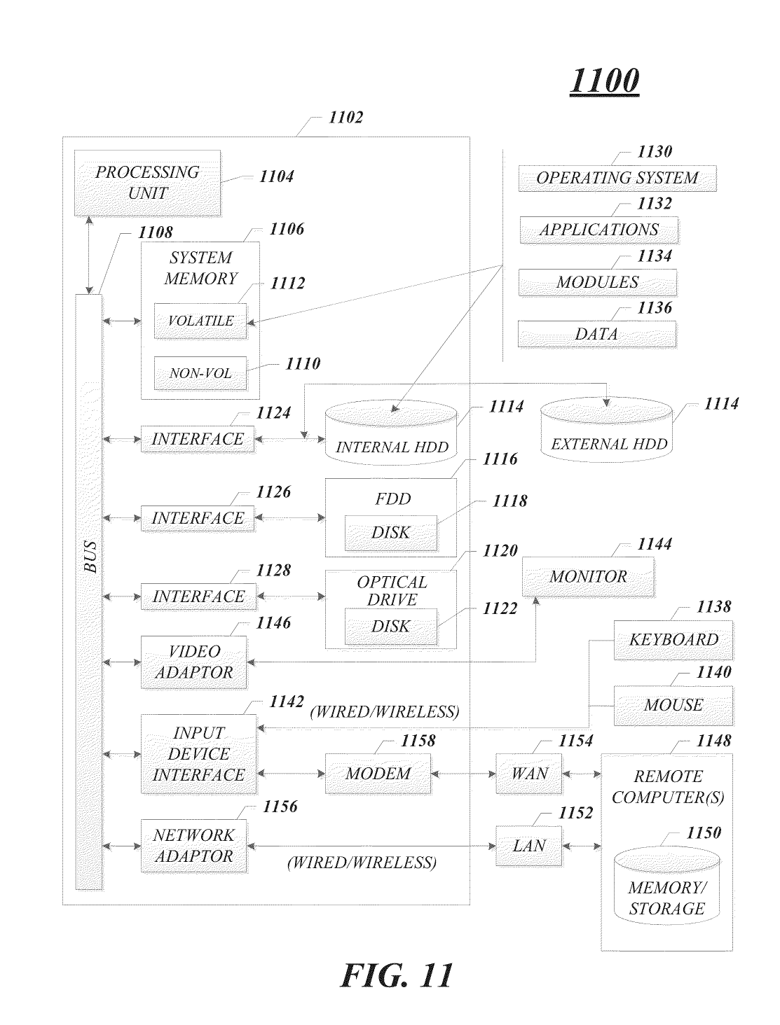

FIG. 11 illustrates an embodiment of an exemplary computing architecture 1100 suitable for implementing various embodiments as previously described. As used in this application, the terms “system” and “device” and “component” are intended to refer to a computer-related entity, either hardware, a combination of hardware and software, software, or software in execution, examples of which are provided by the exemplary computing architecture 1100. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In one embodiment, the computing architecture 1100 may comprise or be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. The embodiments are not limited in this context.

The computing architecture 1100 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 1100.

As shown in FIG. 11, the computing architecture 1100 comprises a processing unit 1104, a system memory 1106 and a system bus 1108. The processing unit 1104 can be any of various commercially available processors. Dual microprocessors and other multi processor architectures may also be employed as the processing unit 1104. The system bus 1108 provides an interface for system components including, but not limited to, the system memory 1106 to the processing unit 1104. The system bus 1108 can be any of several types of bus structure that may further interconnect to a memory bus (with or without a memory controller), a peripheral bus, and a local bus using any of a variety of commercially available bus architectures.

The computing architecture 1100 may comprise or implement various articles of manufacture. An article of manufacture may comprise a computer-readable storage medium to store various forms of programming logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of programming logic may include executable computer program instructions implemented using any suitable type of code, such as source code, compiled code, interpreted code, executable code, static code, dynamic code, object-oriented code, visual code, and the like.

The system memory 1106 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 6, the system memory 1106 can include non-volatile memory 1110 and/or volatile memory 1112. A basic input/output system (BIOS) can be stored in the non-volatile memory 1110.

The computer 1102 may include various types of computer-readable storage media in the form of one or more lower speed memory units, including an internal hard disk drive (HDD) 1114, a magnetic floppy disk drive (FDD) 1116 to read from or write to a removable magnetic disk 1118, and an optical disk drive 1120 to read from or write to a removable optical disk 1122 (e.g., a CD-ROM or DVD). The HDD 1114, FDD 1116 and optical disk drive 1120 can be connected to the system bus 1108 by a HDD interface 1124, an FDD interface 1126 and an optical drive interface 1128, respectively. The HDD interface 1124 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1110, 1112, including an operating system 1130, one or more application programs 1132, other program modules 1134, and program data 1136.

A user can enter commands and information into the computer 1102 through one or more wire/wireless input devices, for example, a keyboard 1138 and a pointing device, such as a mouse 1140. Other input devices may include a microphone, an infrared (IR) remote control, a joystick, a game pad, a stylus pen, touch screen, or the like. These and other input devices are often connected to the processing unit 1104 through an input device interface 1142 that is coupled to the system bus 1108, but can be connected by other interfaces such as a parallel port, IEEE 1394 serial port, a game port, a USB port, an IR interface, and so forth.

A monitor 1144 or other type of display device is also connected to the system bus 1108 via an interface, such as a video adaptor 1146. In addition to the monitor 1144, a computer typically includes other peripheral output devices, such as speakers, printers, and so forth.

The computer 1102 may operate in a networked environment using logical connections via wire and/or wireless communications to one or more remote computers, such as a remote computer 1148. The remote computer 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the LAN 1152 through a wire and/or wireless communication network interface or adaptor 1156. The adaptor 1156 can facilitate wire and/or wireless communications to the LAN 1152, which may also include a wireless access point disposed thereon for communicating with the wireless functionality of the adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, connects to the system bus 1108 via the input device interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A proximity sensor apparatus, comprising:
multiple optical fibers each having an open end, the multiple optical fibers operative to conduct light and arranged such that the open ends for the multiple optical fibers form a grid;
multiple light sources communicatively coupled with corresponding optical fibers, the multiple light sources operative to emit light through an open end of corresponding optical fibers; and
multiple photoelectric sensors communicatively coupled with corresponding optical fibers, the multiple photoelectric sensors operative to detect emitted light that has been reflected back off an object into the open end of one or more of the multiple optical fibers.

2. The proximity sensor apparatus of claim 1 comprising:
a processing component communicatively coupled with the multiple photoelectric sensors operative to:
receive signals from the multiple photoelectric sensors, the signals indicative of the detected reflected emitted light; and
process the signals to determine a distance from an open end of one or more of the multiple optical fibers to the object that reflected the emitted light.

3. The proximity sensor apparatus of claim 1 wherein the multiple light sources emit infrared (IR) light.

4. The proximity sensor apparatus of claim 3 further comprising a modulation component operative to modulate the infrared (IR) light to a specific pattern.

5. The proximity sensor apparatus of claim 4 wherein the processing component is operative to filter the signals indicative of the detected emitted light to disregard light not matching the modulated specific pattern.

6. The proximity sensor apparatus of claim 1 comprising a touch screen positioned beneath the multiple optical fibers.

7. The proximity sensor apparatus of claim 2 wherein the processing component is operative to:
determine an approximation planar location of the object based on the signals; and
initiate an action based on the planar location of the object and the distance.

8. A method comprising:
conducting light from multiple light sources through a set of corresponding multiple optical fibers, each optical fiber having a source end and an open end, the multiple optical fibers communicatively coupled on the source end with corresponding light sources and arranged such that the open ends form a grid;
emitting the light out the open end of the optical fibers;
detecting reflected light that has been reflected back off an object and through open ends of optical fibers, the reflected light detected by multiple photoelectric sensors;
receiving signals from the multiple photoelectric sensors, the signals indicative of the detected reflected light; and
processing the signals to determine a distance from an open end of one or more of the multiple optical fibers to the object that reflected the emitted light.

9. The method of claim 8 wherein the light from multiple light sources is infrared (IR) light.

10. The method of claim 8 comprising modulating the light in a specific pattern.

11. The method of claim 10 comprising filtering the signals indicative of the detected reflected emitted light to disregard light not matching the modulated specific pattern.

12. The method of claim 8 comprising:
determining an approximation of a planar location of the object based on the signals; and
initiating an action based on the planar location and the distance.

13. The method of claim 8 wherein the detected reflected light that has been reflected back off an object is detected through open ends of a second set of optical fibers that is different from the set of optical fibers that emitted the light.

14. A proximity sensor apparatus, comprising:
a first set of multiple optical fibers each having an open end, the multiple optical fibers operative to conduct light and arranged such that the open ends for the first set of multiple optical fibers form a first grid;
a second set of multiple optical fibers each having an open end, the multiple optical fibers operative to conduct light and arranged such that the open ends for the second set of multiple optical fibers form a second grid;
multiple light sources communicatively coupled with corresponding optical fibers in the second set of multiple optical fibers, the multiple light sources operative to emit light through an open end of corresponding optical fibers; and
multiple photoelectric sensors communicatively coupled with corresponding optical fibers in the second set of multiple optical fibers, the multiple photoelectric sensors operative to detect emitted light that has been reflected back off an object into the open end of one or more of the multiple optical fibers.

15. The proximity sensor apparatus of claim 14 comprising:
a processing component communicatively coupled with the multiple photoelectric sensors operative to:
receive signals from the multiple photoelectric sensors, the signals indicative of the detected reflected emitted light; and
process the signals to determine a distance from an open end of one or more of the multiple optical fibers to the object that reflected the emitted light.

16. The proximity sensor apparatus of claim 14 wherein the multiple light sources emit infrared (IR) light.

17. The proximity sensor apparatus of claim 16 further comprising a modulation component operative to modulate the infrared (IR) light to a specific pattern.

18. The proximity sensor apparatus of claim 17 wherein the processing component is operative to filter the signals indicative of the detected emitted light to disregard light not matching the modulated specific pattern.

19. The proximity sensor apparatus of claim 15 comprising a touch screen positioned beneath the first and second sets of multiple optical fibers.

20. The proximity sensor apparatus of claim 16 wherein the processing component is operative to:
determine an approximate planar location of the object based on the signals; and
initiate an action based on the planar location of the object and the distance.

21. A proximity sensor apparatus, comprising:
a touch screen positioned beneath the grid of multiple optical fibers, the touchscreen including multiple light sources operative to emit infrared (IR) light;
multiple optical fibers each having an open end, the multiple optical fibers operative to conduct light and arranged such that the open ends for the multiple optical fibers form a grid; and
multiple photoelectric sensors communicatively coupled with corresponding optical fibers, the multiple photoelectric sensors operative to detect emitted infrared (IR) light that has been reflected back off an object into the open end of one or more of the multiple optical fibers.

22. The proximity sensor apparatus of claim 21 further comprising a modulation component operative to modulate the infrared (IR) light to a specific pattern.

23. The proximity sensor apparatus of claim 22 comprising:
a processing component communicatively coupled with the multiple photoelectric sensors operative to:
receive signals from the multiple photoelectric sensors, the signals indicative of the reflected detected emitted infrared (IR) light; and
process the signals to determine a distance from an open end of one or more of the multiple optical fibers to the object that reflected the emitted infrared (IR) light.

24. The proximity sensor apparatus of claim 23 wherein the processing component is operative to filter the signals indicative of the detected emitted infrared (IR) light to disregard light not matching the modulated specific pattern.

25. The proximity sensor apparatus of claim 23 wherein the processing component is operative to:
determine an approximate planar location of the object based on the signals; and
initiate an action based on the planar location of the object and the distance.
